(19) United States
(12) Patent Application Publication
(10) Pub. No.: US 2023/0368059 A1
(43) Pub. Date: Nov. 16, 2023

(54) TUNABLE BUS FOR OPERATING CROSS-RESONANCE QUANTUM GATES

(71) Applicant: International Business Machines Corporation, Armonk, NY (US)

(72) Inventors: David C. Mckay, Ossining, NY (US); Jiri Stehlik, New York, NY (US); Abhinav Kandala, Yorktown Heights, NY (US)

(21) Appl. No.: 17/663,087

(22) Filed: May 12, 2022

(51) Int. Cl. G06N 10/40; G06N 10/20

(52) U.S. Cl. CPC G06N 10/40; G06N 10/20

(57) ABSTRACT

Techniques regarding qubit coupling systems are provided. For example, one or more embodiments described herein can regard a method comprising controlling quantum gate operations by driving a static coupling between a first qubit and a second qubit. The method can also comprise controlling quantum interactions between the first qubit or the second qubit by tuning a frequency of a microwave resonator bus.

### BACKGROUND

The subject disclosure relates to one or more gate sequences for operating a tunable microwave resonator bus, and more specifically, to operating cross-resonance quantum gate operations between fixed frequency superconducting qubits via a coupling system that includes a tunable microwave resonator bus.

A method for coupling qubits can comprise coupling them individually to a common resonator bus, where the frequency of the qubits is far detuned from the bus. For example, two or more superconducting Josephson junction qubits (e.g., transmon qubits) can be capacitively coupled to a length (“L”) of co-planar waveguide, which can have a resonance where the wavelength is twice the length of the waveguide (e.g., a “L/2” resonator). For instance, the resonator bus can have no photons and so can be removed from the quantum dynamics and converted into an effective qubit-qubit coupling. However, qubit coupling via the resonator bus can result in multiple crosstalk quantum interactions, such as: ZZ interactions, ZX interactions, and/or IX interactions.

To account for the ZZ interaction, a static coupling can be added between the qubits. For example, the static coupling can be arranged in parallel to the resonator bus to alter the relationship between coupling strength (“J”) and the ZZ interaction. Capacitor values within the coupling system can be adjusted such that the total J and ZZ interaction values are cancelled or only the ZZ interaction is cancelled. However, despite cancelling the ZZ interaction, other crosstalk quantum interactions remain. To account for one or more of the other crosstalk quantum interactions, the frequency of the resonator bus can be tuned. For example, tunability can be added to the bus by adding a superconducting quantum interference device (“SQUID”) loop to the resonator, or by replacing the bus with a SQUID tunable qubit. Operation of the resonator coupler can comprise moving the frequency of the bus into a high ZZ interaction region for quantum gate operation and then back to a minimized quantum interaction region for quiescent operation.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, methods (e.g., computer-implemented methods), and/or computer program products that can operate cross-resonance quantum gate operations between superconducting qubits are described.

According to an embodiment, a method is provided. The method can comprise controlling quantum gate operations by driving a static coupling between a first qubit and a second qubit. The method can also comprise controlling quantum interactions between the first qubit or the second qubit by tuning a frequency of a microwave resonator bus. An advantage of such a method can be the operation of an all-microwave multi-qubit device while mitigating cross-talk from other qubits.

In some implementations the method can comprise setting the frequency of the microwave resonator bus to a first frequency such that a first amount of magnetic flux is established. For example, a collective strength of the quantum interactions can be minimized at the first frequency. An advantage of such a method can be the inhibiting of cross-resonance interactions to a near zero level and the mitigation of undesirable ZZ interactions.

According to another embodiment, a method is provided. The method can comprise generating a first calibration dataset regarding drive frequencies of a first qubit and a second qubit at a first amount of magnetic flux of a tunable microwave resonator bus. The method can also comprise generating a second calibration dataset regarding a single qubit gate and a cross-resonance gate between the first qubit and the second qubit at a second amount of magnetic flux of the tunable microwave resonator bus. An advantage of such a method can be calibrating a qubit coupling system that requires less frequency shift of the tunable microwave resonator bus to actualize quantum gate operations.

In some implementations the method can comprise setting the tunable microwave resonator bus to a second frequency associated with the second amount of magnetic flux to enable the quantum interactions. The method can also comprise applying a localized cross-resonance drive frequency to the first qubit while the tunable microwave resonator bus is at the second frequency. An advantage of a such a method can be the ability to define the second frequency based on CR interaction rather than merely ZZ interaction.

According to another embodiments, a method is provided. The method can comprise defining a qubit connectivity sub-lattice from a fixed grid lattice of qubits. The qubit connectivity sub-lattice can be composed of a group of qubits from the fixed grid lattice that are operably coupled by cross-resonance gate operations and tunable microwave resonator buses. An advantage of such a method can be the implementation of customizable qubit connectivity schemes from qubit topology represented by the fixed grid lattice.

In some implementations the method can also comprise defining a second qubit connectivity sub-lattice from the fixed grid lattice of qubits. The second qubit connectivity sub-lattice can be composed of a second group of qubits from the fixed grid lattice. Further, the qubit connectivity sub-lattice can be distinct from the second qubit connectivity sub-lattice. An advantage of such a method can be the ability to define effective qubit connectivity of a fixed qubit topology to serve multiple distinct qubit devices.

### BRIEF DESCRIPTION OF THE DRAWINGS

FIG. 1 illustrates a diagram an example, non-limiting qubit coupling system that can incorporate quantum crosstalk cancelling and cross-resonance (“CR”) gate operation in accordance with one or more embodiments described herein.

FIG. 2 illustrates a diagram of an example, non-limiting graph that can regard one or more quantum interactions associated with a qubit coupling system in accordance with one or more embodiments described herein.

FIG. 3 illustrates a flow diagram of an example, non-limiting method to facilitate a calibration procedure for operating one or more qubit coupling systems in accordance with one or more embodiments described herein.

FIG. 4 illustrates a diagram of an example, non-limiting graph that can depict a calibration procedure for operating one or more qubit coupling systems in accordance with one or more embodiments described herein.

FIG. 5 illustrates a diagram of an example, non-limiting qubit coupling system between three superconducting qubits that can incorporate quantum crosstalk cancelling and cross-resonance (“CR”) gate operation in accordance with one or more embodiments described herein.

FIG. 6 illustrates a diagram of example, non-limiting graphs that can regard one or more quantum interactions associated with a qubit coupling system between three superconducting qubits in accordance with one or more embodiments described herein.

FIG. 7 illustrates a diagram of an example, non-limiting qubit coupling system operation that can be employed to enable or disable qubit connectivity in accordance with one or more embodiments described herein.

FIG. 8 illustrates a diagram of an example, non-limiting qubit connectivity topology that can be achieved from a fixed grid lattice via one or more qubit coupling systems in accordance with one or more embodiments described herein.

FIG. 9 illustrates a diagram of an example, non-limiting qubit connectivity topology that can be achieved from a fixed grid lattice via one or more qubit coupling systems in accordance with one or more embodiments described herein.

FIG. 10 illustrates a flow diagram of an example, non-limiting method for operating one or more qubit coupling systems to enable quantum crosstalk cancelling and cross-resonance (“CR”) gate operation in accordance with one or more embodiments described herein.

FIG. 11 illustrates a flow diagram of an example, non-limiting method for defining qubit connectivity topologies from a fixed grid lattice using one or more qubit coupling systems in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In typical qubit coupling methodologies, a drive crosstalk can remain when implementing single qubit gates. Also, a crosstalk can remain with regards to spectator qubits when implementing two-qubit gates. Additionally, traditional methodologies for cancelling cross talk can necessitate large frequency shifts of the resonator bus to activate gate operation. The large frequency shifts can result in undesirable leakage levels and/or conflicts with spectator qubits. Given the problems with traditional qubit coupling operations; the present disclosure can be implemented to produce a solution to one or more of these problems by operating a tunable flux qubit coupling system such that a multi-qubit gate can be an all-microwave CR gate while flux tuning can be implemented for inhibiting or enabling quantum interactions. As such, various embodiments described herein can be implemented to control ZZ interaction mitigation and CR gate operations.

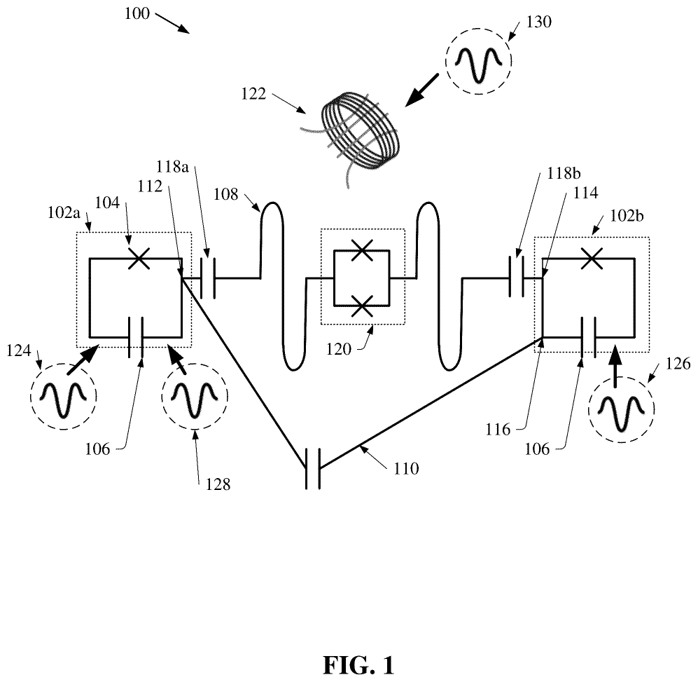

FIG. 1 illustrates a diagram of an example, non-limiting qubit coupling system 100 in accordance with one or more embodiments described herein. As shown in FIG. 1, the qubit coupling system 100 can be employed to operably couple two or more qubits 102. In one or more embodiments, the coupled qubits 102 can be fixed frequency superconducting Josephson junction based qubits (e.g., transmon qubits). Further, the qubit coupling system 100 can be included in one or more quantum computers (e.g., including one or more quantum processors).

For instance, one or more quantum computers comprising the qubit coupling system 100 can include quantum hardware devices that can utilize the laws of quantum mechanics (e.g., such as superposition and/or quantum entanglement) to facilitate computational processing (e.g., while satisfying the DiVincenzo criteria). Quantum computers can comprise, for example: a quantum data plane, a control processor plane, a control and measurement plane, and/or a qubit technology.

In one or more embodiments, the quantum data plane can include one or more quantum circuits comprising physical qubits, structures to secure the positioning of the qubits, and/or support circuitry. The support circuitry can, for example, facilitate measurement of the qubits' state and/or perform gate operations on the qubits (e.g., for a gate-based system). In some embodiments, the support circuitry can comprise a wiring network that can enable multiple qubits to interact with each other. Further, the wiring network can facilitate the transmission of control signals via a direct electrical connection and/or electromagnetic radiation (e.g., optical, microwave, and/or low-frequency signals). For instance, the support circuitry can comprise one or more superconducting resonators operatively coupled to the one or more qubits. As described herein the term “superconducting” can characterize a material that exhibits superconducting properties at or below a superconducting critical temperature, such as aluminum (e.g., superconducting critical temperature of 1.2 Kelvin) or niobium (e.g., superconducting critical temperature of 9.3 Kelvin). Additionally, one of ordinary skill in the art will recognize that other superconductor materials (e.g., hydride superconductors, such as lithium/magnesium hydride alloys) can be used in the various embodiments described herein. In various embodiments, the qubit coupling system 100 can be included in the quantum data plane of one or more quantum computers.

In one or more embodiments, the control processor plane can identify and/or trigger a Hamiltonian sequence of quantum gate operations and/or measurements, wherein the sequence executes a program (e.g., provided by a host processor) for implementing a quantum algorithm. For example, the control processor plane can convert compiled code to commands for the control and measurement plane. In one or more embodiments, the control processor plane can further execute one or more quantum error correction algorithms. In various embodiments, the one or more qubits, and thereby the qubit coupling system 100, can be operably connected to, and/or controlled by, the control processor plane of a quantum computer.

In one or more embodiments, the control and measurement plane can convert digital signals generated by the control processor plane, which can delineate quantum operations to be performed, into analog control signals to perform the operations on the one or more qubits 102 in the quantum data plane. Also, the control and measurement plane can convert one or more analog measurement outputs of the qubits 102 in the data plane to classical binary data that can be shared with other components of a computer system (e.g., which can further comprise classical computer architectures)

In various embodiments, the one or more coupled qubits 102 can be superconducting qubits (e.g., such as superconducting quantum interference devices “SQUIDs”), which can be lithographically defined electronic circuits that can be cooled to milli-Kelvin temperatures to exhibit quantized energy levels (e.g., due to quantized states of electronic charge or magnetic flux). Superconducting qubits can be Josephson junction-based, such as transmon qubits and/or the like. Also, superconducting qubits can be compatible with microwave control electronics, and can be utilized with gate-based technology or integrated cryogenic controls. Additional exemplary qubit technologies can include, but are not limited to: photonic qubits, quantum dot qubits, gate-based neutral atom qubits, semiconductor qubits (e.g., optically gated or electrically gated), topological qubits, a combination thereof, and/or the like.

As shown in FIG. 1, the qubit coupling system 100 can operably couple a first qubit 102a and a second qubit 102b (e.g., denoted with dotted lines in FIG. 1). Further, the qubits 102 can include one or more Josephson junctions 104 (e.g., denoted with an “X” in FIG. 1) and/or capacitor pads 106. While multiple Josephson junctions 104 are shown in FIG. 1 (e.g., as denoted with X's in FIG. 1), a single Josephson junction is labelled with the respective reference numeral to avoid obscuring the figures.

The qubits 102 can be coupled to each other via a microwave resonator bus 108 and/or a capacitor device 110. For instance, the microwave resonator bus 108 can be directly coupled between a first terminal 112 of the first qubit 102a and a second terminal 114 of the second qubit 102b. Additionally, the capacitor device 110 can be cross coupled between the first terminal 112 and a third terminal 116 of the second qubit 102b. In one or more embodiments, the first terminal 112 and the second terminal 114 can have the same voltage polarities. Also, the first terminal 112 and the third terminal 116 can have opposite voltage polarities. In various embodiments, the capacitor device 110 can comprise one or more capacitor components including, but not limited to: a differential capacitor (e.g., a capacitor that can connect opposite voltage paddles of a transmon qubit), a bypass capacitor, a combination thereof, and/or the like.

The microwave resonator bus 108 can be coupled to qubits 102 via capacitive couplings 118. For instance, the microwave resonator bus 108 can be coupled to the first qubit 102a via a first capacitive coupling 118a and to the second qubit 102b via a second capacitive coupling 118b. Additionally, the microwave resonator bus 108 can comprise one or more SQUID loops 120 and/or SQUID tunable qubits. The one or more SQUID loops 120 can comprise multiple Josephson junctions 104 (e.g., denoted by X's in FIG. 1). In various embodiments, the one or more SQUID loops 120 can be employed to control the tunability of the microwave resonator bus 108 as described herein. For example, a tunable magnetic flux 122 can interact with the one or more SQUID loops 120. In various embodiments, the microwave resonator bus 108 can comprise one or more tunable devices including, but not limited to: a flux tunable coupler, a tunable coupler qubit, a flux tunable coupler qubit, a tunable qubit, a tunable bus, a flux tunable qubit bus, a combination thereof, and/or the like.

In various embodiments, the qubits 102 can be coupled to one or more pulse generator devices that can generate one or more signal tones to drive the first qubit 102a, the second qubit 102b, and/or one or more quantum gate operations. Example pulse generator devices can include, but are not limited to: an arbitrary waveform generator (“AWG”), a vector network analyzer (“VNA”), a combination thereof, and/or the like. Additionally, the microwave resonator bus 108 can be operably coupled to one or more high-speed flux lines (“HSFL”) that can generate magnetic flux to tune the microwave resonator bus 108. Thereby, the qubit coupling system 100 can operate based on a first qubit drive frequency 124 of the first qubit 102a, a second qubit drive frequency 126 of the second qubit 102b, a CR drive frequency 128 applied to the first qubit 102a, and/or a tunable frequency 130 of the microwave resonator bus 108.

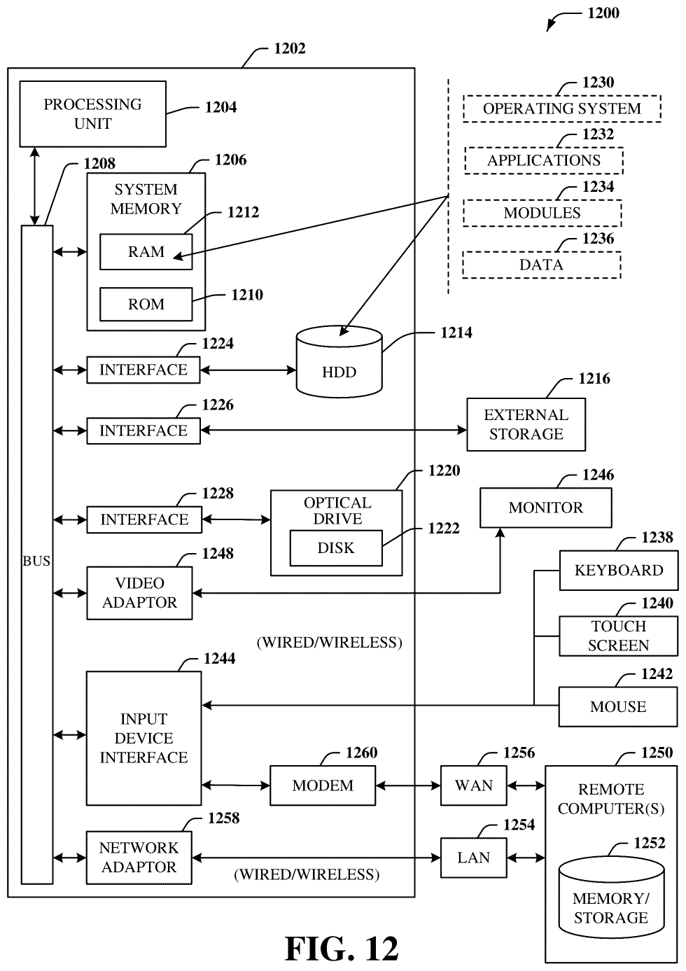

In one or more embodiments, the pulse generator device and/or the HSFL can be coupled to, and thereby controlled via, one or more classical computer components and/or quantum computer components. For example, a pulse generator device (e.g., an AWG, a VNA, etc.) can be coupled to a computer (e.g., computer 1212 described below with reference to FIG. 12) comprising a memory (e.g., system memory 1216 described below with reference to FIG. 12) that can store instructions thereon (e.g., software, routines, processing threads, etc.) and a processor (e.g., processing unit 1214 described below with reference to FIG. 12) that can execute such instructions that can be stored on the memory. In this example embodiment, such a computer can be employed to operate and/or control (e.g., via processing unit 1214 executing instructions stored on system memory 1214) such a pulse generator device (e.g., an AWG, a VNA, etc.), thereby enabling the pulse generator device to transmit and/or receive pulses (e.g., microwave pulses) to and/or from the qubits 102 and/or qubit coupling system 100.

In various embodiments, the magnetic flux 122 of the microwave resonator bus 108 can be tuned to adjust the tunable frequency 130. Further, adjusting the tunable frequency 130 can control the amount of quantum interactions (e.g., XZ interactions, IX interactions, and/or ZZ interactions) between the qubits 102 (e.g., between the first qubit 102a and the second qubit 102b). For example, the effective coupling strength of the qubit coupling system 100 can be a function of coupling due to the microwave resonator bus 108 and coupling due to the capacitor device 110, where the microwave resonator bus 108 coupling and the capacitor device 110 coupling can have a cancelling relationship (e.g., the coupling value due to the microwave resonator bus 108 (“J_{bus}”) can be a negative value, while the coupling value due to the capacitor device 110 can be a positive value). Thereby, the tunable frequency 130 can be tuned to inhibit quantum interactions (e.g., thereby mitigating crosstalk between qubits 102) and/or enable finite amounts of quantum interaction (e.g., thereby enabling one or more quantum gate operations). For instance, the capacitor device 110 can cancel the coupling between the qubits 102 at a particular tunable frequency 130 value of the microwave resonator bus 108. Additionally, the CR drive frequency 128 can be applied to establish a multi-qubit quantum gate, such as an all-microwave cross-resonance gate operation via the capacitor device 110.

In accordance with various embodiments herein, the tunable frequency 130 of the microwave resonator bus 108 can be far detuned from the first qubit drive frequency 124 of the first qubit 102a and/or the second qubit drive frequency 126 of the second qubit 102b. As the microwave resonator bus 108 is detuned further from the qubits 102, the coupling strength due to the microwave resonator bus 108 (J_{bus}) diminishes. In one or more embodiments, the tunable frequency 130 of the microwave resonator bus 108 can be detuned to one or more values below the frequency of the qubits 102. Alternatively, in some embodiments the tunable frequency 130 of the microwave resonator bus 108 can be detuned to one or more values above the frequency of the qubits 102 (e.g., the capacitor device 110 can be coupled between the first terminal 112 of the first qubit 102a and the second terminal 114 of the second qubit 102b). One or more quantum interactions, such as crosstalk caused by ZZ interaction, can be a function of the microwave resonator bus 108-qubit 102 detuning.

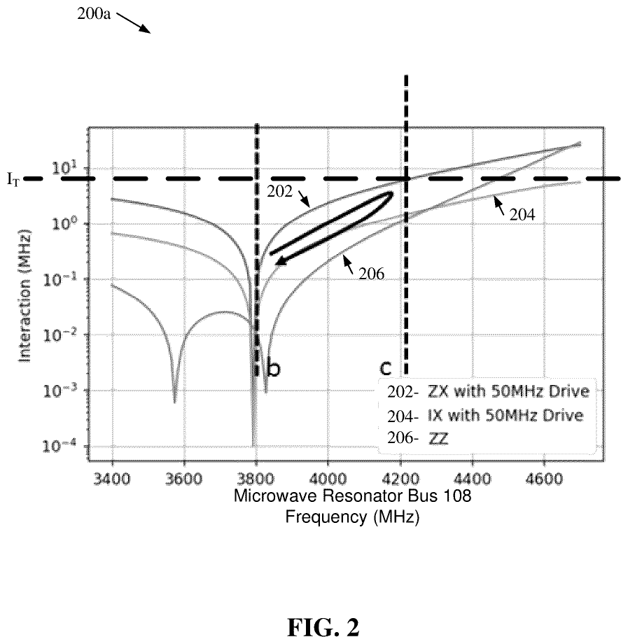

FIG. 2 illustrates a diagram of an example, non-limiting quantum interaction graph 200a that can depict the strength of quantum interactions between the qubits 102 when the microwave resonator bus 108 is set to different tunable frequency 130 values in accordance with one or more embodiments described herein. Repetitive description of like elements employed in other embodiments described herein is omitted for the sake of brevity. As shown in FIG. 2, line 202 can represent an amount of ZX interaction (e.g., cross-resonance interaction) between the qubits 102; line 204 can represent an amount of IX interaction between the qubits 102; and/or line 206 can represent an amount of ZZ interaction between the qubits 102.

Further, bold dashed lines can delineate position B and position C on the quantum interaction graph 200a. For example, the magnetic flux 122 can be tuned such that the tunable frequency 130 of the microwave resonator bus 108 is at a first value (e.g., about 3700 MHz in quantum interaction graph 200a) at position B and a second value (e.g., about 4250 MHz in quantum interaction graph 200a) at position C. While the tunable frequency 130 is at position B, the collective strength of the quantum interactions can be minimized. For instance, the strength of the ZX and/or IX interactions can approach zero, and the strength of the ZZ interaction can be mitigated (e.g., to about 10⁻² MHz in quantum interaction graph 200a). Thereby, when the microwave resonator bus 108 is tuned to position B, quantum interaction between the qubits 102 can be substantially inhibited (e.g., thereby quantum cross-talk between the qubits 102 can be mitigated).

While the tunable frequency 130 is at position C, the one or more quantum interactions (e.g., ZX, IX, and/or ZZ interactions) between the qubits 102 can be present to a finite amount. Further, the CR drive frequency 128 can be applied to the first qubit 102a while the microwave resonator bus 108 is tuned to position C; thereby establishing a CR gate between the first qubit 102a and the second qubit 102b (e.g., the CR drive frequency 128 can be equivalent to the second qubit drive frequency 126 of the second qubit 102b). Thus, the microwave resonator bus 108 can be tuned between position C, to enable quantum gate operations (e.g., which can be controlled via CR drive frequency 128 via the capacitor device 110), and position B, to disable quantum gate operations while mitigating quantum cross-talk.

Additionally, application of the CR drive frequency 128 to control the CR gate between the qubits 102 (e.g., via the capacitor device 110) can enable position C to be set based on the ZX interaction (e.g., cross-resonance interaction) rather than based on the ZZ interaction. Traditionally, position C was set based on the strength of the ZZ interaction such that position C is in a high ZZ region in order realize a desired amount of effective quantum interaction. Advantageously, controlling CR gate operation via the CR drive frequency 128 enables position C to be set based on the strength of the ZX interaction (e.g., cross-resonance interaction), which can achieve the same desired amount of effective quantum interaction at a lower tunable frequency value 130.

For instance, quantum interaction graph 200a depicts a defined quantum interaction threshold (“I_{T}”), which can define an amount of quantum interaction desired to facilitate one or more CR gate operations. The defined quantum interaction threshold can be set based on, for example: a desired functionality of the qubit coupling system 100, a quality of the qubits 102, one or more coupling strength values of the qubit coupling system 100, and/or a quality of the microwave resonator bus 108. As shown in quantum interaction graph 200a, due to the quantum gate being an all-microwave CR gate controlled by the locally applied CR drive frequency 128, the defined quantum interaction threshold can be achieved based on the ZX interaction at a lower tunable frequency 130 of the microwave resonator bus 108 than if based on the ZZ interaction. Thereby, the amount of phase shift associated with the transition from position B to position C, and vice versa, can be reduced and/or minimized (e.g., compared to traditional operating methodologies) to improve quantum gate speed. Additionally, reducing the amount of shifting of the tunable frequency 130 can avoid crossings with leakage levels or spectator qubits (not shown).

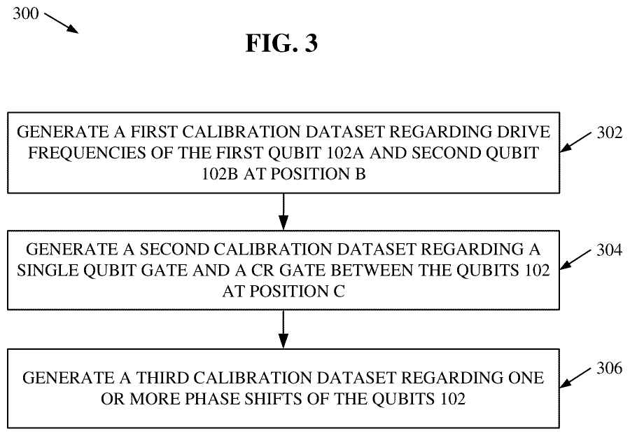

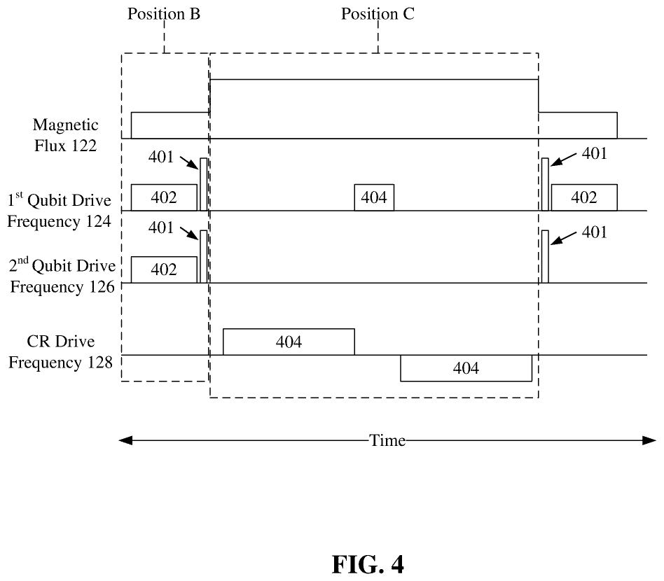

FIGS. 3-4 can regard one or more calibration procedures 300 that can be employed to operate the qubit coupling system 100 in accordance with one or more embodiments described herein. FIG. 3 depicts a flow diagram of one or more methods 300 that can facilitate execution of the one or more calibration procedures, and FIG. 4 depicts frequency relationships that can be calibrated by one or more calibration procedures. Also shown in FIG. 4, the bounds of position C frequency shift can be marked by one or more virtual Z pules 401. The virtual Z pulses 401 can be “zero length” in software pulses that rotate the phase. They would be part of position B. Repetitive description of like elements employed in other embodiments described herein is omitted for the sake of brevity.

At 302, the method 300 can comprise generating a first calibration dataset 402 regarding the drive frequencies (e.g., first qubit drive frequency 124 and/or second qubit drive frequency 126) of the first qubit 102a and the second qubit 102b at position B (e.g., where the microwave resonator bus 108 can be set to a tunable frequency 130 that substantially inhibits quantum interactions). For example, FIG. 4 shows an exemplary depiction of the first calibration dataset 402 in relation to position B, the first qubit drive frequency 124, the second qubit drive frequency 126, and the CR drive frequency 128. In various embodiments, the first calibration dataset 402 can characterize a universal set of fully tuned up single qubit gates (for operation at position B).

At 304, the method 300 can comprise generating a second calibration dataset 404 regarding a single qubit gate and/or a CR gate between the qubits 102 at position C (e.g., where the microwave resonator bus 108 can be set to a tunable frequency 130 that enables a desired amount of quantum interactions). For example, FIG. 4 shows an exemplary depiction of the second calibration dataset 404 in relation to position C, the first qubit drive frequency 124, the second qubit drive frequency 126, and the CR drive frequency 128. In various embodiments, the second calibration dataset 404 can be all the pulses to construct a two-qubit entangling gate with the CR interaction.

At 306, the method 300 can comprise generating a third calibration dataset regarding one or more phase shifts of the qubits 102. For example, the pulses defined in the first calibration dataset 402 can be at different frequencies than those defined in the second calibration dataset 404, thereby associating one or more phase shifts to the first qubit 102a and/or second qubit 102b. In one or more embodiments, the one or more phase shifts can be calibrated via one or more ramsey sequences.

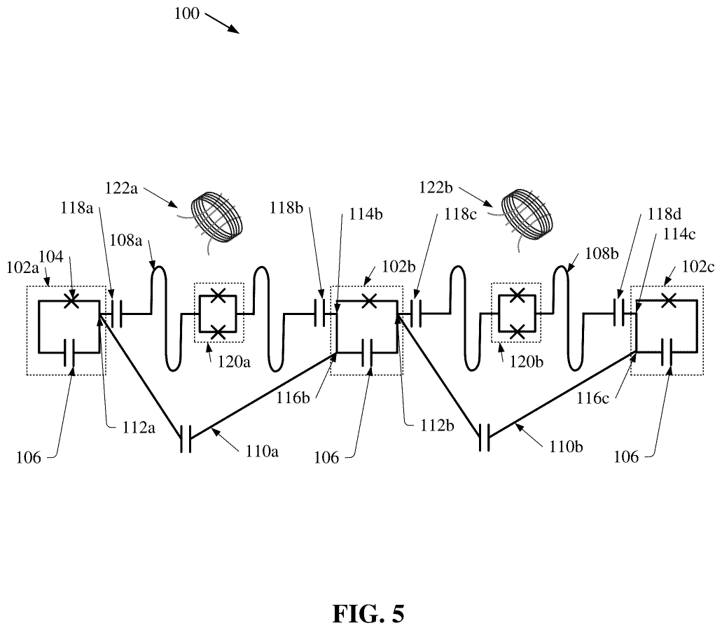

FIG. 5 illustrates a diagram of the example, non-limiting qubit coupling system 100 further comprising a third qubit 102c in accordance with one or more embodiments described herein. Repetitive description of like elements employed in other embodiments described herein is omitted for the sake of brevity. While FIG. 5 depicts an exemplary embodiment of the qubit coupling system 100 comprising three qubits 102, the architecture of the qubit coupling system 100 is not so limited. For example, embodiments in which the qubit coupling system 100 couples more than three qubits 102 are also envisaged.

As shown in FIG. 5, the qubit coupling system 100 can control: a first microwave resonator bus 108a between the first qubit 102a and the second qubit 102b, and a second microwave resonator bus 108b between the second qubit 102b and a third qubit 102c. For instance, the first microwave resonator bus 108a can be tuned via a first magnetic flux 122a threaded through one or more first SQUID loops 120a in accordance with various embodiments described herein. Additionally, the second microwave resonator bus 108b can be tuned via a second magnetic flux 122b threaded through one more second SQUID loops 120b in accordance with various embodiments described herein.

Additionally, a first all-microwave CR gate between the first qubit 102a and the second qubit 102b can be controlled, for example, via a first capacitor device 110a. Likewise, a second all-microwave CR gate between the second qubit 102b and the third qubit 102c can be controlled, for example, via a second capacitor device 110b.

As shown in FIG. 5, the first microwave resonator bus 108a can be coupled between a first terminal 112a of the first qubit 102a and a second terminal 114b of the second qubit 102b, which can have the same voltage polarities. Further the second microwave resonator bus 108b can be coupled between a first terminal 112b of the second qubit 102b and a second terminal 114c of the third qubit 102c, which can have the same voltage polarities. Also, the first capacitor device 110a can be coupled between the first terminal 112a of the first qubit 102a and the third terminal 116b of the second qubit 102b, which can have different voltage polarities from each other. Additionally, the second capacitor device 110b can be coupled between the first terminal 112b of the second qubit 102b and the third terminal 116c of the third qubit 102c, which can have different voltage polarities from each other.

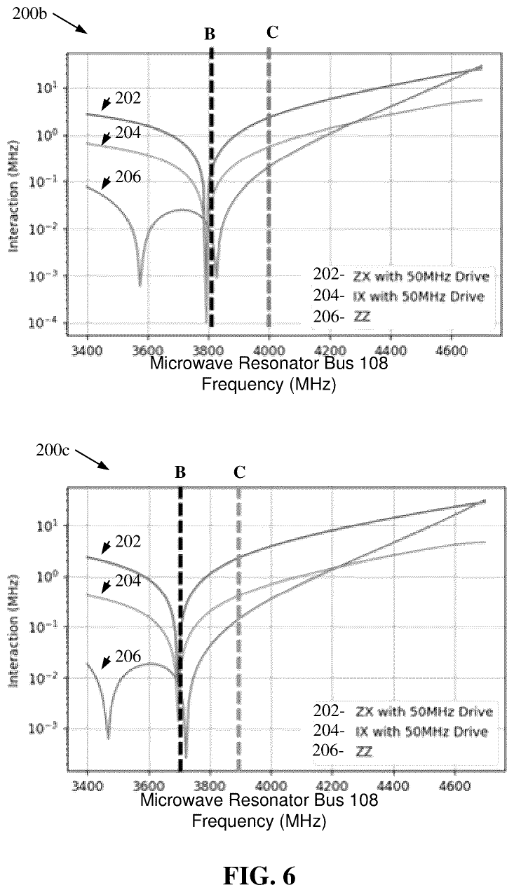

FIG. 6 illustrates a diagram of an example, non-limiting second quantum interactions graph 200b and/or third quantum interactions graph 200c regarding the qubit coupling system 100 in accordance with one or more embodiments described herein. Repetitive description of like elements employed in other embodiments described herein is omitted for the sake of brevity. The second quantum interactions graph 200b can regard quantum interactions between the first qubit 102a and the second qubit 102b in the qubit coupling system 100 shown in FIG. 5. The third quantum interactions graph 200c can regard quantum interactions between the second qubit 102b and the third qubit 102c in the qubit coupling system 100 shown in FIG. 6.

In accordance with various embodiments described herein, the second quantum interactions graph 200b and the third quantum interactions graph 200c can regard the qubit coupling system 100 shown in FIG. 5 under the following example conditions: the first qubit drive frequency 124 of the first qubit 102a can be 5 gigahertz (GHz); the second qubit drive frequency 126 of the second qubit 102b can be 4.92 GHz; a third qubit drive frequency of the third qubit 102c can be 4.98 GHz; qubit coupling established by the first capacitor device 110a (e.g., between the first qubit 102a and the second qubit 102b) can be 11 MHz; qubit coupling established by the second capacitor device 110b (e.g., between the second qubit 102b and the third qubit 102c) can be 10 MHz; coupling established by the capacitive couplings 118a, 118b, 118c, and/or 118d can be 120 MHz; and the anharmonicity of the qubits 102 can be −330 MHz.

As shown in the second quantum interactions graph 200b, quantum interactions between the first qubit 102a and the second qubit 102b can be inhibited when the first microwave resonator bus 108a is set to a frequency associated with position B. Likewise, as shown in the third quantum interactions graph 200c, quantum interactions between the second qubit 102b and the third qubit 102c can be inhibited when the second microwave resonator bus 108b is set to a frequency associated with position B. Additionally, quantum interactions between the first qubit 102a and the second qubit 102b can be enabled when the first microwave resonator bus 108a is set to a frequency associated with position C in the second quantum interactions graph 200b. Likewise, quantum interactions between the second qubit 102b and the third qubit 102c can be enabled when the second microwave resonator bus 108b is set to a frequency associated with position C in the third quantum interactions graph 200c.

In various embodiments, the first microwave resonator bus 108a can be tuned to a frequency associated with position C on the second quantum interactions graph 200b while the second microwave resonator bus 108b is tuned to a frequency associated with position B on the third quantum interactions graph 200c. Thereby, the first microwave resonator bus 108a can enable a CR gate operation between the first qubit 102a and the second qubit 102b (e.g., controlled via the first capacitor device 110a) while inhibiting quantum interactions (e.g., noise and/or cross-talk) from the third qubit 102c. Also, the second microwave resonator bus 108b can be tuned to a frequency associated with position C on the third quantum interactions graph 200c while the first microwave resonator bus 108a is tuned to a frequency associated with position B on the second quantum interactions graph 200b. Thereby, the second microwave resonator bus 108b can enable a CR gate operation between the second qubit 102b and the third qubit 102c (e.g., controlled via the second capacitor device 110b) while inhibiting quantum interactions (e.g., noise and/or cross-talk) from the first qubit 102a. For example, the CR gate between the first qubit 102a and the second qubit 102b can be operated at a different time stage than the CR gate between the second qubit 102b and the third qubit 102c.

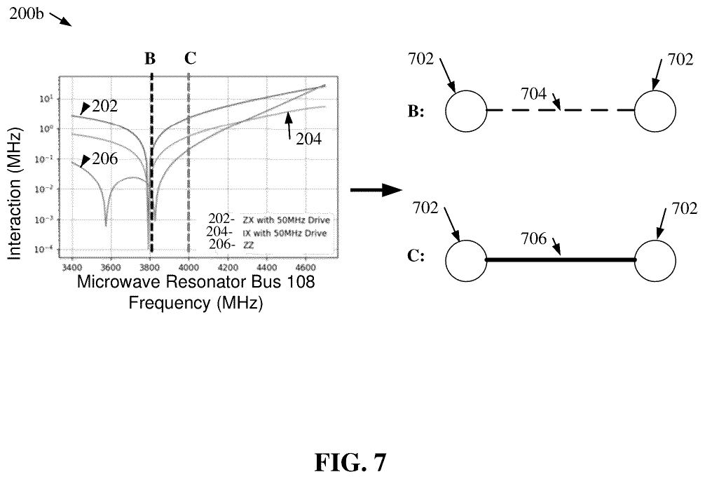

FIG. 7 illustrates a diagram of an example, non-limiting qubit connectivity scheme 700 that can represent operation of the qubit coupling system 100 in accordance with one or more embodiments described herein. Repetitive description of like elements employed in other embodiments described herein is omitted for the sake of brevity. As shown in FIG. 7, the qubit connectivity scheme 700 can represent qubits 102 via respective nodes 702 and lines between the nodes 702 can denote qubit coupling established by the microwave resonator bus 108 and/or capacitor device 110. Further, dashed interconnecting lines can denote a CR disconnect 704, where the qubits 102 remain coupled via the qubit coupling system 100 but a CR gate operation in not enabled. Also, bold interconnecting lines can denote a CR connection 706, where the qubits 102 are coupled via the qubit coupling system 100 and an all-microwave CR gate operation is applicable.

As shown in FIG. 7, a CR disconnect 704 between qubits 102 can be established when the associate microwave resonator bus 108 is tuned to a frequency corresponding to position B in the associate quantum interactions graph 200 for the qubit coupling system 100. Also, a CR connection 706 can be established when the associate microwave resonator bus 108 is tuned to a frequency corresponding to position C in the associate quantum interactions graph 200 for the qubit coupling system 100.

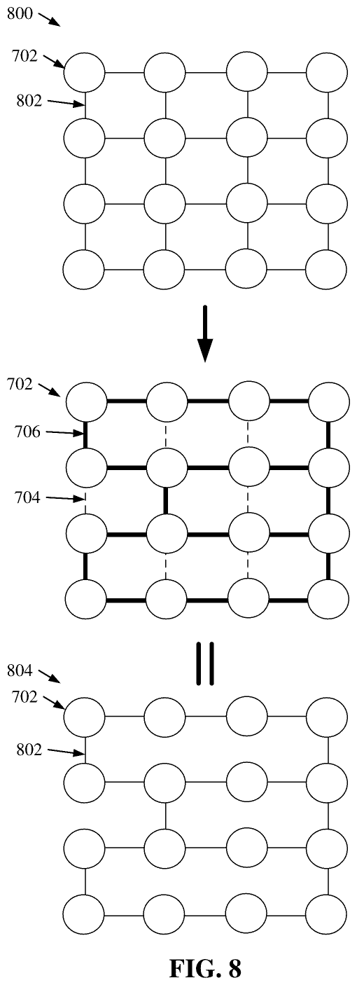

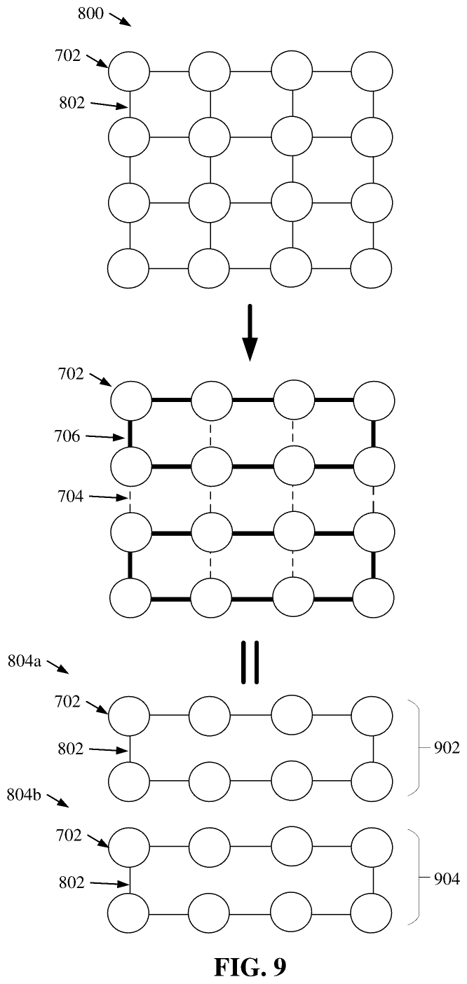

As shown in FIGS. 8-9, the qubit connectivity scheme 700, and the qubit coupling system 100, can be employed to define the qubit sub-topology for a quantum device (e.g., a quantum processor). FIGS. 8-9 illustrate diagrams of example, non-limiting qubit topologies that can be derived from a common fixed grid lattice 800 in accordance with one or more embodiments described herein. Repetitive description of like elements employed in other embodiments described herein is omitted for the sake of brevity. In various embodiments, the fixed grid lattice 800 can represent qubit connectivity within a quantum computer (e.g., a quantum processor). While FIGS. 8-9 depict the fixed grid lattice 800 as a 4×4 square grid, the architecture of the fixed grid lattice 800 is not so limited. For example, embodiments in which the fixed grid lattice comprises fewer or more qubits 102 and/or geometric arrangements (e.g., a heavy hexagon lattice) are also envisaged.

As shown in FIGS. 8-9, the fixed grid lattice 800 can comprise a plurality of nodes 702 that can represent respective qubits 102. Further, the fixed grid lattice 800 can comprise a plurality of interconnect lines 802, which can represent the qubit coupling system 100 (e.g., each interconnect line 802 can represent a respective combination of a microwave resonator bus 108 and capacitor device 110). While multiple nodes 702 and/or interconnect lines 802 are shown in FIGS. 8-9, a single node 702 and a single interconnect line 802 are labelled with the respective reference numerals to avoid obscuring the figures.

Amongst the qubit-qubit couplings established by the qubit coupling system 100 and represented by the interconnect lines 802, respective microwave resonator buses 108 can be tuned to establish CR disconnects 704 or CR connections 706 between nodes 702. Qubits 102 coupled by a CR connection 706 can be subject to one or more CR gate operations, while qubits 102 coupled by a CR disconnect 704 can be subject to restricted and/or isolated connectivity. While multiple CR disconnects 704 and/or CR connections 706 are shown in FIGS. 8-9, a single CR disconnect 704 and a CR connection 706 are labelled with the respective reference numerals to avoid obscuring the figures.

Thereby, despite each qubit 102 of the fixed grid lattice 800 being coupled to each other (e.g., directly or indirectly), qubit connectivity can be selectively enabled or disabled via tuning of the microwave resonator buses 108 to define a qubit connectivity sub-lattice 804 from the fixed grid lattice 800. For instance, example qubit connectivity sub-lattice 804 can represent those nodes 702 connected by CR connections 706. Thus, in one or more embodiments the qubit coupling system 100 and/or qubit connectivity scheme 700 can be employed to define a lower qubit connectivity sub-lattice 804 from the fixed grid lattice 800.

Additionally, FIG. 9 exemplifies that the qubit coupling system 100 and/or qubit connectivity scheme 700 can be employed to define a plurality of lower qubit connectivity sub-lattices 804 from the fixed grid lattice 800. For example, a microwave resonator buses 108 can be tuned so as to define a first qubit connectivity sub-lattice 804a and a distinct second qubit connectivity sub-lattice 804b from the fixed grid lattice 800. Further, the first qubit connectivity sub-lattice 804a can characterize the effective qubit topology of a first quantum device 902 (e.g., a first quantum processor), while the second qubit connectivity sub-lattice 804b can characterize the effective qubit topology of a second quantum device 904 (e.g., a second quantum processor).

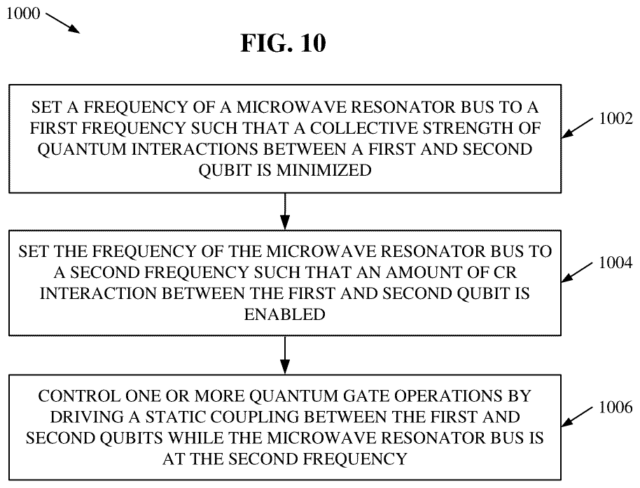

FIG. 10 illustrates a flow diagram of an example, non-limiting method 1000 that can regard operating one or more qubit coupling systems 100 in accordance with one or more embodiments described herein. Repetitive description of like elements employed in other embodiments described herein is omitted for the sake of brevity.

At 1002, the method 1000 can comprise setting a frequency (e.g., a tunable frequency 130) of one or more microwave resonator buses 108 to a first frequency such that a collective strength of quantum interactions between a first qubit 102a and a second qubit 102b can be minimized. For example, the one or more microwave resonator buses 108 can be set to position B based on associate quantum interactions graphs 200, whereby ZX and/or IX interactions can approach zero and ZZ interactions can be minimal. For instance, an amount of magnetic flux 122 threaded through one or more SQUID loops 120 of the one or more microwave resonator buses 108 can be adjusted to facilitate the setting at 1002.

At 1004, the method 1000 can comprise setting the frequency (e.g., the tunable frequency 130) of the one or more microwave resonator buses 108 to a second frequency such that an amount of CR interaction between the first qubit 102a and the second qubit 102b can be enabled. For example, the one or more microwave resonator buses 108 can be set to position C based on associate quantum interactions graphs 200, whereby a desired amount of quantum interaction can be achieved based on a strength of the ZX interaction (e.g., the CR interaction). For instance, an amount of magnetic flux 122 threaded through one or more SQUID loops 120 of the one or more microwave resonator buses 108 can be adjusted to facilitate the setting at 1004.

At 1006, the method 1000 can comprise controlling one or more quantum gate operations (e.g., CR gates) by driving a static coupling (e.g., a capacitor device 110) between the first qubit 102a and the second qubit 102b while the one or more microwave resonator buses 108 are at the second frequency. For example, a localized CR drive frequency 128 can be applied to one of the qubits 102 (e.g., the first qubit 102a) to control operation of a CR gate between the qubits 102. For instance, driving the static coupling at 1006 can establish an all-microwave CR gate between the qubits 102.

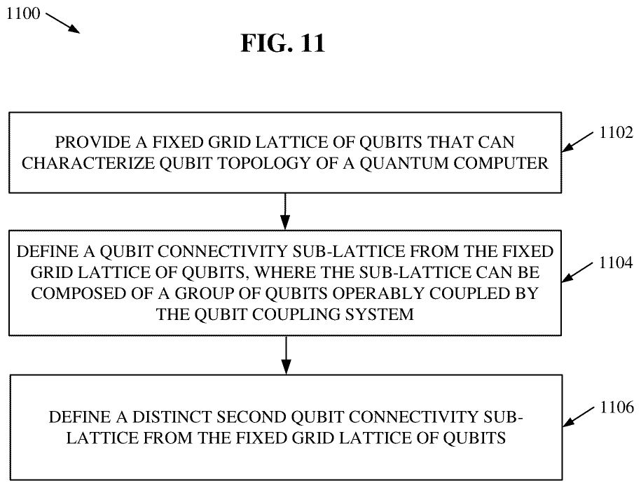

FIG. 11 illustrates a flow diagram of an example, non-limiting method 1100 that can facilitate defining qubit connectivity from a fixed grid lattice 800 in accordance with one or more embodiments described herein. Repetitive description of like elements employed in other embodiments described herein is omitted for the sake of brevity.

At 1102, the method 1100 can comprise providing a fixed grid lattice 800 of qubits 102 that can characterize qubit topology of one or more quantum computers. For example, the fixed grid lattice 800 can represent the number, type, and/or hardware connection of one or more qubits 102 comprised within one or more quantum computers. At 1104, the method 1100 can comprise defining one or more qubit connectivity sub-lattices 804 from the fixed grid lattice 800 of qubits, where the one or more qubit connectivity sub-lattices 804 can be composed of one or more groups of qubits 102 operably coupled by the qubit coupling system 100. For example, method 1000 can be employed to establish CR disconnects 704 and/or CR connections 706 within the fixed grid lattice 800 (e.g., as exemplified in FIGS. 8-9). Thereby, qubit connectivity sub-lattice 804 with a lower effective connectivity can be defined from the hardware-coupled qubits 102 represented by the fixed grid lattice 800. In one or more embodiments, at 1106 the method 1100 can further comprise defining one or more second qubit connectivity sub-lattices 804 from the fixed grid lattice 800 that can be distinct from the qubit connectivity sub-lattice 804 defined at 1104. For instance, FIG. 9 exemplifies that the qubit coupling system 100 can be operated (e.g., via method 1000) to establish two effective quantum devices (e.g., such as a first quantum device 902 having a first qubit topology and/or a second quantum device 904 having a second qubit topology).

In various embodiments, methods 400, 1000, and/or 1100 can be computer-implemented via one or more computer environments, cloud computer environments, and/or quantum computer environments. For example, operation and/or calibration of the qubit coupling system 100 can be performed, and/or facilitated, by a system, a computer-implemented method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

In order to provide additional context for various embodiments described herein, FIG. 12 and the following discussion are intended to provide a general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, and/or the like, that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (“IoT”) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (“RAM”), read only memory (“ROM”), electrically erasable programmable read only memory (“EEPROM”), flash memory or other memory technology, compact disk read only memory (“CD-ROM”), digital versatile disk (“DVD”), Blu-ray disc (“BD”) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (“BIOS”) can be stored in a non-volatile memory such as ROM, erasable programmable read only memory (“EPROM”), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (“HDD”) 1214 (e.g., EIDE, SATA), one or more external storage devices 1216 (e.g., a magnetic floppy disk drive (“FDD”) 1216, a memory stick or flash drive reader, a memory card reader, a combination thereof, and/or the like) and an optical disk drive 1220 (e.g., which can read or write from a disk 1222, such as: CD-ROM disc, a DVD, a BD, and/or the like). While the internal HDD 1214 is illustrated as located within the computer 1202, the internal HDD 1214 can also be configured for external use in a suitable chassis (not shown). Additionally, while not shown in environment 1200, a solid state drive (“SSD”) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (“USB”) and Institute of Electrical and Electronics Engineers (“IEEE”) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (“VM”) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (“TPM”). For instance with a TPM, boot components hash next in time boot components, and wait for a match of results to secured values, before loading a next boot component. This process can take place at any layer in the code execution stack of computer 1202, e.g., applied at the application execution level or at the operating system (“OS”) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (“IR”) remote control, a radio frequency (“RF”) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, and/or the like.

A monitor 1246 or other type of display device can be also connected to the system bus 1208 via an interface, such as a video adapter 1248. In addition to the monitor 1246, a computer typically includes other peripheral output devices (not shown), such as speakers, printers, a combination thereof, and/or the like.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (“LAN”) 1254 and/or larger networks, e.g., a wide area network (“WAN”) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (“AP”) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, and/or the like), and telephone. This can include Wireless Fidelity (“Wi-Fi”) and BLUETOOTH® wireless technologies. Thus, the communication can be a predefined structure as with a conventional network or simply an ad hoc communication between at least two devices.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
controlling quantum gate operations by driving a static coupling between a first qubit and a second qubit; and
controlling quantum interactions between the first qubit or the second qubit by tuning a frequency of a microwave resonator bus.

2. The method of claim 1, further comprising:
setting the frequency of the microwave resonator bus to a first frequency such that a first amount of magnetic flux is established, wherein a collective strength of the quantum interactions is minimized at the first frequency.

3. The method of claim 2, further comprising:
setting the frequency of the microwave resonator bus to a second frequency to enable a cross-resonance interaction between the first qubit and the second qubit, wherein an all-microwave cross-resonance gate is formed by driving the static coupling while the microwave resonator bus is at the second frequency.

4. The method of claim 3, wherein an effective amount of cross-resonance interaction between the first qubit and the second qubit approaches zero at the first frequency and is greater than or equal to a defined threshold at the second frequency.

5. The method of claim 3, wherein the quantum interactions include a ZZ interaction, ZX interaction, and IX interaction, and wherein a strength of the ZZ interaction at the second frequency is less than the respective strengths of the ZX interaction and the IX interaction.

6. The method of claim 3, wherein the first qubit and the second quit are fixed frequency superconducting qubits, and wherein the microwave resonator bus comprises a superconducting quantum interference device loop.

7. The method of claim 1, wherein the static coupling and the microwave resonator bus are arranged in parallel between the first qubit and the second qubit, wherein the static coupling is a bypass capacitor coupled to first set of terminals of the first qubit and the second qubit having opposite voltage polarities, and wherein the microwave resonator bus is coupled to a second set of terminals of the first qubit and the second qubit having same voltage polarities.

8. A method, comprising:
generating a first calibration dataset regarding drive frequencies of a first qubit and a second qubit at a first amount of magnetic flux of a tunable microwave resonator bus; and
generating a second calibration dataset regarding a single qubit gate and a cross-resonance gate between the first qubit and the second qubit at a second amount of magnetic flux of the tunable microwave resonator bus.

9. The method of claim 8, wherein microwave pulses defined in the first calibration dataset have a different frequency than microwave pulses defined in the second calibration dataset, and wherein the method further comprises:
generating a third calibration dataset regarding one or more phase shifts of the first qubit and the second qubit.

10. The method of claim 9, further comprising:
setting the tunable microwave resonator bus to a first frequency associated with the first amount of magnetic flux to minimize a collective strength of quantum interactions between the first qubit and the second qubit.

11. The method of claim 10, further comprising:
setting the tunable microwave resonator bus to a second frequency associated with the second amount of magnetic flux to enable the quantum interactions; and
applying a localized cross-resonance drive frequency to the first qubit while the tunable microwave resonator bus is at the second frequency.

12. The method of claim 11, wherein the first qubit is coupled to the second qubit via the tunable microwave resonator bus and a bypass capacitor arranged in parallel to each other.

13. The method of claim 12, wherein the first qubit and the second qubit are fixed frequency superconducting qubits, and wherein the tunable microwave resonator bus comprises a superconducting quantum interference device loop.

14. A method, comprising:
defining a qubit connectivity sub-lattice from a fixed grid lattice of qubits, wherein the qubit connectivity sub-lattice is composed of a group of qubits from the fixed grid lattice that are operably coupled by cross-resonance gate operations and tunable microwave resonator buses.

15. The method of claim 14, wherein adjacent qubits of the fixed grid lattice are coupled together by the tunable microwave resonator buses.

16. The method of claim 15, further comprising:
setting a first tunable microwave resonator bus to a first frequency to minimize one or more quantum interactions between a first qubit pair from the group of qubits from the fixed grid lattice that are not directly connected in the qubit connectivity sub-lattice.

17. The method of claim 16, further comprising:
setting a second tunable microwave resonator bus to a second frequency that enables a cross-resonance gate operation via a bypass capacitor coupling between a second qubit pair from the qubits from the fixed grid lattice that are directly connected in the qubit connectivity sub-lattice.

18. The method of claim 14, further comprising:
defining a second qubit connectivity sub-lattice from the fixed grid lattice of qubits, wherein the second qubit connectivity sub-lattice is composed of a second group of qubits from the fixed grid lattice, and wherein the qubit connectivity sub-lattice is distinct from the second qubit connectivity sub-lattice.

19. The method of claim 18, wherein the qubit connectivity sub-lattice is associated with a first quantum processor, and wherein the second qubit connectivity sub-lattice is associated with a second quantum processor.

20. The method of claim 17, wherein qubits from the fixed grid lattice are fixed frequency superconducting qubits.
